(19) United States
(12) Patent Application Publication
(10) Pub. No.: US 2025/0134249 A1
(43) Pub. Date: May 1, 2025

(54) Storage Apparatuses and Storage Apparatus systems

(71) Applicant: Robert Daniel Webb, Bells, TN (US)

(72) Inventor: Robert Daniel Webb, Bells, TN (US)

(21) Appl. No.: 18/929,041

(22) Filed: Oct. 28, 2024

Related U.S. Application Data
(60) Provisional application No. 63/545,842, filed on Oct. 26, 2023.

(51) Int. Cl. A47B 81/00; B44C 5/02

(52) U.S. Cl. CPC A47B 81/005; B44C 5/02

(57) ABSTRACT

A storage apparatus comprising a chamber defined by a first sidewall, a second sidewall, a upper wall, a lower wall, a proximal end, a first distal end, and a second distal end. The upper wall having a first length measured from the proximal end to the first distal end. The upper wall having a second length measured from the proximal end to the second distal end. The first length being greater than the second length. A first indentation in the first sidewall. The first indentation adapted to receive a magnet. A metallic member embedded between the first sidewall and a first sidewall outer surface.

### FIELD

The disclosure relates to the field of storage apparatuses. More particularly, the disclosure relates to storage apparatuses and systems useful for storing a firearm. Specific storage apparatuses and storage apparatus systems are provided.

### BACKGROUND

The possession of firearms requires responsible ownership and diligent safety practices. To safeguard against unauthorized access, accidents, and misuse, firearm owners often store their firearms securely when not in use. Having safe firearm storage is important.

A need exists, therefore, for improved storage apparatuses and storage apparatus systems.

### BRIEF SUMMARY OF SELECTED EXAMPLES

Various example storage apparatuses are described.

An example storage apparatus comprises a chamber defined by a first sidewall, a second sidewall, an upper wall, a lower wall, a proximal end, a first distal end, and a second distal end. The upper wall having a first length measured from the proximal end to the first distal end. The upper wall having a second length measured from the proximal end to the distal end. The first length being greater than the second length. A first indentation in the side wall, the first indentation adapted to receive a magnet. A metallic member embedded between the first sidewall and a first sidewall outer surface.

Another example storage apparatus comprises a chamber defined by a first sidewall, a second sidewall, an upper wall, a lower wall, a first distal wall, a proximal end, a first distal end, and a second distal end. The upper wall having a first length measured from the proximal end to the first distal end. The upper wall having a second length measured from the proximal end to the second distal end. The first length being greater than the second length. A first indentation in the first distal wall, the first indentation adapted to receive a magnet. A metallic member embedded between the first distal wall and the first distal end.

Various example storage apparatus systems are described.

An example storage apparatus system comprises a wall ornament. A storage apparatus disposed within the wall ornament, the storage apparatus having a chamber defined by a first sidewall, a second sidewall, an upper wall, a lower wall, a proximal end, a first distal end, and a second distal end. The first sidewall having a first length measured from the proximal end to the first distal end. The upper wall having a second length measured from the proximal end to the second distal end, the first length being greater than the second length. A first indentation in the first sidewall, the first indentation adapted to receive a magnet, a metallic member embedded between the first sidewall and a first sidewall outer surface. A bracket attached to the wall ornament. The bracket configured to move the wall ornament.

Additional understanding of the inventive storage apparatuses and systems can be obtained by reviewing the detailed description of selected examples, below, and the referenced drawings.

### DESCRIPTION OF FIGURES

FIG. 1 is a perspective view of a first example storage apparatus.

FIG. 2 is a perspective view of the first example storage apparatus.

FIG. 3 is a perspective view of the first example storage apparatus.

FIG. 4 is a side view of the first example storage apparatus.

FIG. 5 is a side view of the first example storage apparatus.

FIG. 6 is a side view of the first example storage apparatus.

FIG. 7 is a side view of the first example storage apparatus.

FIG. 8 is a perspective view of a second example storage apparatus.

FIG. 9 is a side perspective view of the second example storage apparatus.

FIG. 10 is a perspective view of a third example storage apparatus.

FIG. 11 is a perspective view of the third example storage apparatus.

FIG. 12 is a perspective view of a fourth example storage apparatus.

FIG. 13 is a perspective view of a first example storage apparatus system.

FIG. 14 is a perspective view of a fifth example storage apparatus.

### DETAILED DESCRIPTION OF SELECTED EXAMPLES

The following detailed description and the appended drawings describe and illustrate various example storage apparatuses and storage apparatus systems. The description and illustration of these examples enable one skilled in the art to make and use examples of storage apparatuses and storage apparatus systems. They do not limit the scope of the claims in any manner.

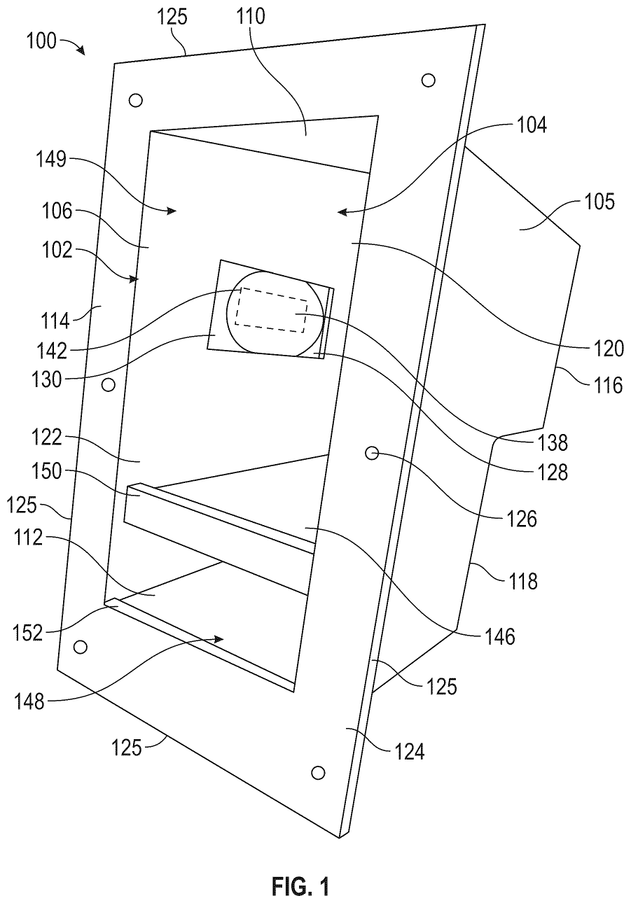

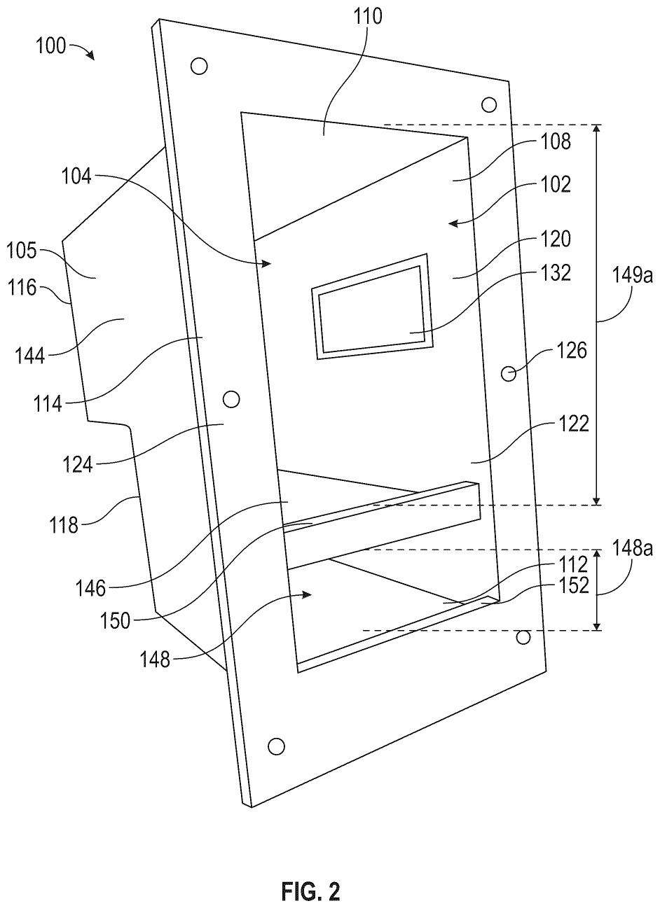

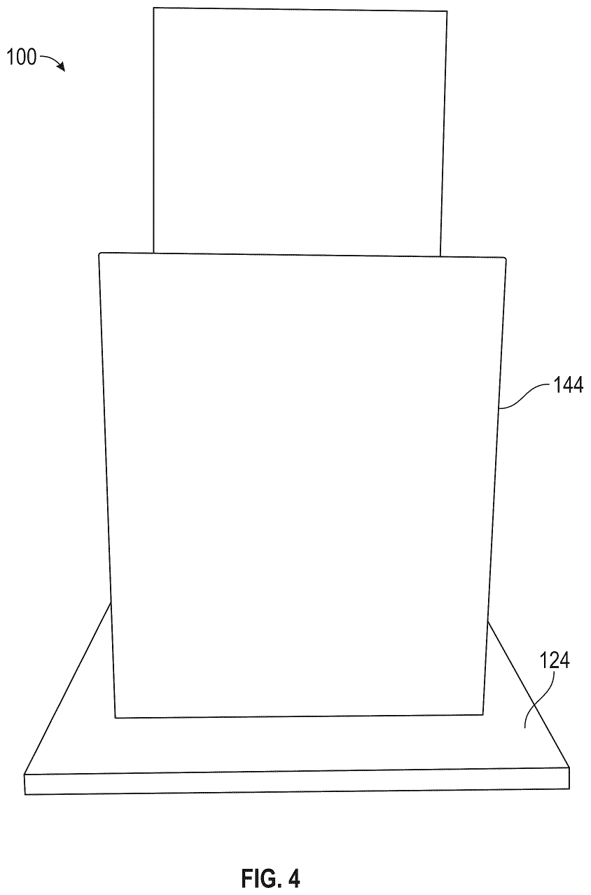

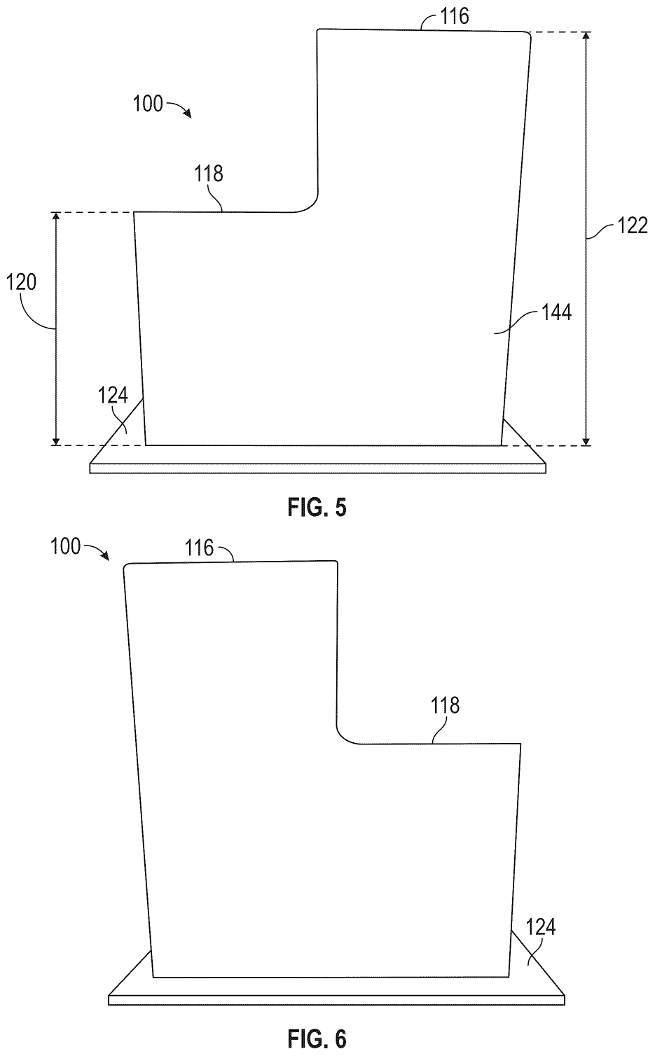

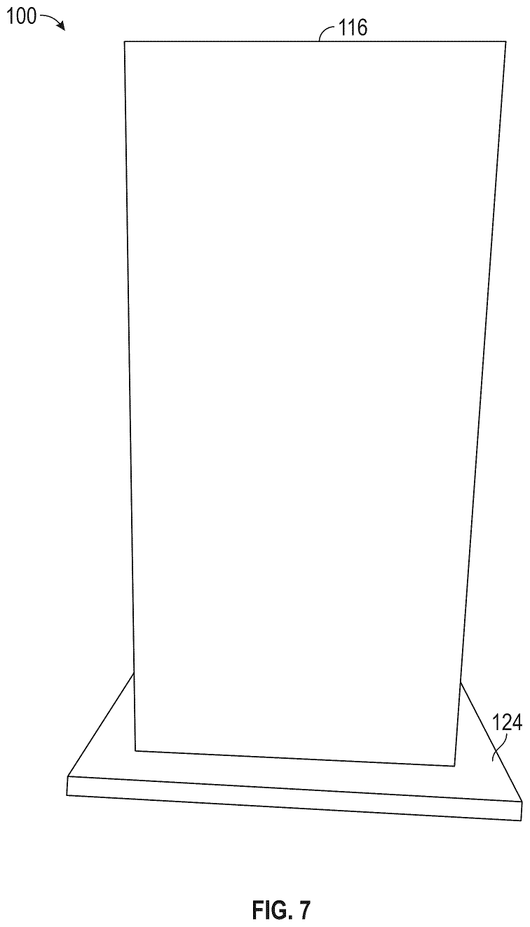

Each of FIGS. 1, 2, 3, 4, 5, 6, and 7 illustrates a first example storage apparatus 100. The storage apparatus 100 can be disposed in a wall ornament. One example of a wall ornament is a taxidermy mount of a deer. However, the taxidermy mount can be of any type of animal including, but not limited to bear, elk, bison, or the like. Although installing the storage apparatus 100 in a taxidermy mount is beneficial, the storage apparatus 100 can be installed in or designed integral to any type of wall hung decoration having dimensions that allows for the installation of the storage apparatus 100. Further, the storage apparatus 100 can be made by a variety of different processes including, but not limited to, 3d printing, direct injection molding, and by any other desired means. The storage apparatus 100 can also be made from a variety of different materials including, but not limited to, polymers, metals, and the like.

In the illustrated embodiment, the storage apparatus 100 has an opening 102 that is rectangular; however, the opening 102 can be any desired shape including, but not limited to, circular, triangular, hexagonal, or the like. The opening 102 is adapted to receive an object. The storage apparatus 100 has a chamber 104 that is defined by a housing 105 having a first sidewall 106, a second sidewall 108, an upper wall 110, a lower wall 112, a proximal end 114, a first distal end 116, and a second distal end 118. In the illustrations, the first sidewall 106 is relatively perpendicular to the upper wall 110. The upper wall 110 is relatively perpendicular to the second sidewall 108. The second sidewall 108 is relatively perpendicular to the lower wall 112. The lower wall 112 is relatively perpendicular to the first sidewall 106. Although the storage apparatus 100 is illustrated in this manner, the walls 106, 108, 110, 112 do not need to be perpendicular to each other. The walls can be positioned to have a variety of angles to form a variety of shapes depending on the type of object that will be stored. In the illustrated embodiment, the upper wall 110 and lower wall 112 have a width that is approximately 10 cm (3.94 in) measured from the first sidewall 106 to the second sidewall 108. A first portion 120 of the chamber 104 has a first length measured from a proximal end 114 to a first distal end 116. In the illustrated embodiment, the first portion 120 is approximately 23 cm (9.06 in) measured from the proximal end 114 to the first distal end 116. Further, a second portion 122 of the chamber 104 has a second length measured from the proximal end 114 to a second distal end 118. In the illustrated embodiment, the second portion 122 is approximately 13.5 cm (5.31 in) measured from the proximal end 114 to the second distal end 118. The first portion 120 and the second portion 122 need not be these exact dimensions. The first portion 120 and the second portion 122 can have any desired dimensions. The chamber 104 having these dimensions makes the chamber 104 adapted to receive a firearm. For example, a pistol, a revolver, or the like can be the type of firearms that the chamber 104 is adapted to receive. In further embodiments, the chamber 104 can be larger and adapted to store other types of firearms, such as shotguns and rifles, can be stored within the storage apparatus 100. In some embodiments, the first portion 120 of the chamber 104 is tapered from the proximal end 114 to the first distal end 116.

In the illustrated embodiment, the storage apparatus 100 further has a flange 124 attached to the first sidewall 106, the second sidewall 108, the upper wall 110, and the lower wall 112. The flange 124 is adapted to secure the storage apparatus 100 to a wall ornament. In the illustrated embodiment, the flange 124 is approximately 2 cm (0.79 in) from the first and second sidewalls 106, 108 to an outside edge 125 of the flange 124. Also, the flange 124 is approximately 2.5 cm (0.98 in) from the first and lower wall 110, 112 to the outside edge 125 of the flange 124. However, the flange 124 can be any desired dimensions. Further, the flange 124 can have a plurality of holes 126. Each of the plurality of holes 126 is adapted to receive a fastener to secure the storage apparatus 100 to the wall ornament. In other embodiments, the storage apparatus 100 has a door covering the chamber 104. In even further embodiments, the door has a lock. The lock can be any desired type of lock including, but not limited to a key lock, a combination lock, a fingerprint lock, and the like.

The storage apparatus 100 can have a plurality of indentations 128 that are within the chamber 104. The indentations 128 can be any size and any shape; however, in the illustrated embodiment each of the indentations 128 are rectangular shaped and measure at approximately 4 cm (1.57 in) by 10 cm (3.94 in). The indentations 128 also need not be rectangular. The indentations 128 can be any shape including, but not limited to, circular, pentagonal, hexagonal, or the like. For example, the illustrated embodiment has a first indentation 130 in the first sidewall 106, a second indentation 132 is in the second sidewall 108, and a third and fourth indentation 134, 136 that are in the upper wall 110. Each of the first, second, third, and fourth indentations 130, 132, 134, 136 are adapted to receive a magnet 138, at least partially within the indentations 130, 132, 134, 136. Although the storage apparatus 100 has four indentations 130, 132, 134, 136, any number of indentations 130, 132, 134, 136 can be present. For example, the number of indentations 130, 132, 134, 136 can include, but is not limited to, one, two, three, five, six, seven, or the like. Further, the storage apparatus 100 can be further defined by a first distal wall 140 that is connected to the first sidewall 106 and the second sidewall 108. The first distal wall 140 can also have an indentation 130, 132, 134, 136 that is adapted to receive a magnet 138. In the illustrated embodiment, the magnet 138 is removably disposed within the first indentation 130, but the magnet 138 can be moved to any desired indentation 130, 132, 134, 136 to adjust for the preference of the individual using the storage apparatus 100. The storage apparatus 100 can have any number of magnets 138 including, but not limited to, one, two, three, four, five, or any other desired number that are releasably attached to any or all of the indentations 130, 132, 134, 136. The magnet 138 can be adapted to secure a firearm or any other object having metal within the chamber 104. In the illustrated embodiment, the storage apparatus 100 has a metallic member 142 embedded between the first sidewall 106 and a first sidewall outer surface 144 that is positioned relative to the first indentation 130. There may also be a plurality of metallic members 142 embedded within any of the walls 106, 108, 110, 112 of the storage apparatus 100. The metallic members 142 can also be embedded in places in which there are no indentations present. Further, in alternative embodiments, metallic members 142 may be disposed on the outside of the storage apparatus 100 or within the chamber 104. The indentations 128 can be beneficial for a number of reasons. For example, the indentations 128 are beneficial at least because it prevents the magnet 138 from moving while the wall ornament is moved or bumped. Further, the indentations 128 can be used to add additional support to prevent the firearm, or other objects, being stored from getting damaged. For example, the indentations 128 can have a support member having a felt material disposed over the support member to support the firearm or objects without causing damage.

The illustrated embodiment further has a platform 146 that is extends between the upper wall 110, the lower wall 112, the first sidewall 106, and the second sidewall 108. The platform 146 extends between the first sidewall 106 and the second sidewall 108. The platform 146 is in the chamber 104 and creates a first compartment 148. The first compartment 148 is defined by the platform 146, the first sidewall 106, the second sidewall 108, and the lower wall 112. The platform 146 can further have a platform lip 150 that is adapted to create a shelf within the storage apparatus 100 where objects will not fall off the platform 146. When the platform 146 is present in the storage apparatus 100, a reduced chamber 149 is defined by the first sidewall 106, the second sidewall 108, the upper wall 110, and the platform 146. In the illustrated embodiment, the first compartment 148 has a first height 148a and the reduced chamber 149 has a second height 149a. The first height 148a of the first compartment 148 being less than the second height 149a of the reduced chamber 149. Further, in the illustrated embodiment, the lower wall 112 has a compartment lip 152 that extends over a portion of the compartment 148. In alternative embodiments, the storage apparatus 100 may further comprise a first divider that is disposed within the compartment, thus the divider creates multiple compartments. The divider can be fixed, or it can be removeable as desired. The storage apparatus 100 can further have a second divider disposed within the compartment 148 that is similar to the first divider or identical to the first divider. The storage apparatus 100 can have any number of dividers including, but not limited to, one, two, three, four, or none.

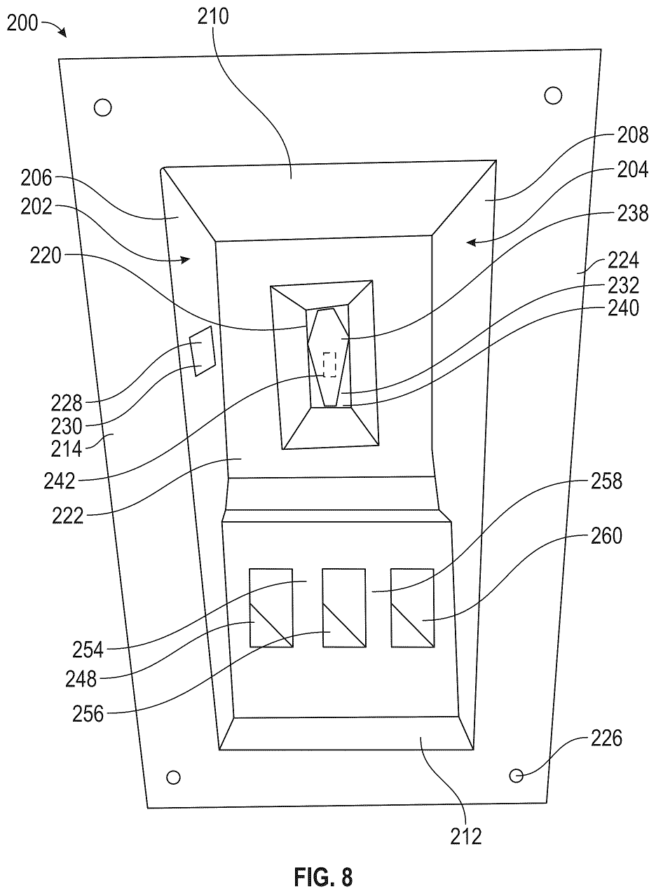

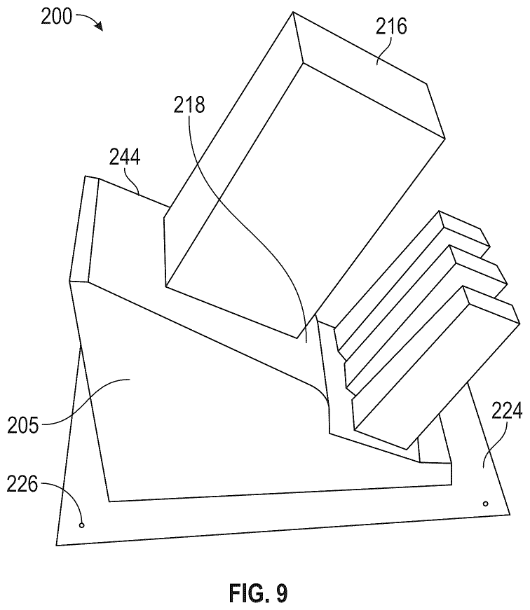

Each of FIGS. 8 and 9 illustrates a second example storage apparatus 200. The storage apparatus 200 can be disposed in a wall ornament. One example of a wall ornament is a taxidermy mount of a deer. However, the taxidermy mount can be of any type of animal including, but not limited to bear, elk, bison, or the like. Although installing the storage apparatus 200 in a taxidermy mount is beneficial, the storage apparatus 200 can be installed in or designed integral to any type of wall hung decoration having dimensions that allows for the installation of the storage apparatus 200. Further, the storage apparatus 200 can be made by a variety of different processes including, but not limited to, 3d printing, direct injection molding, and by any other desired means. The storage apparatus 200 can also be made from a variety of different materials including, but not limited to, polymers, metals, and the like.

In the illustrated embodiment, the storage apparatus 200 has an opening 202 that is rectangular; however, the opening 202 can be any desired shape including, but not limited to, circular, triangular, hexagonal, or the like. The opening 202 is adapted to receive an object. The storage apparatus 200 has a chamber 204 that is defined by a housing 205 having a first sidewall 206, a second sidewall 208, an upper wall 210, a lower wall 212, a proximal end 214, a first distal end 216, and a second distal end 218. In the illustrations, the first sidewall 206 is relatively perpendicular to the upper wall 210. The upper wall 210 is relatively perpendicular to the second sidewall 208. The second sidewall 208 is relatively perpendicular to the lower wall 212. The lower wall 212 is relatively perpendicular to the first sidewall 206. Although the storage apparatus 200 is illustrated in this manner, the walls 206, 208, 210, 212 do not need to be perpendicular to each other. The walls can be positioned to have a variety of angles to form a variety of shapes depending on the type of object that will be stored. A first portion 220 of the chamber 204 has a first length measured from a proximal end 214 to a first distal end 216. Further, a second portion 222 of the chamber 204 has a second length measured from the proximal end 214 to a second distal end 218. The chamber 204 having these dimensions makes the chamber 204 adapted to receive a firearm. For example, a pistol, a revolver, or the like can be the type of firearms that the chamber 204 is adapted to receive. In further embodiments, the chamber 204 can be larger and adapted to store other types of firearms, such as shotguns and rifles, can be stored within the storage apparatus 200. In some embodiments, the first portion 220 of the chamber 204 is tapered from the proximal end 214 to the first distal end 216.

In the illustrated embodiment, the storage apparatus 200 further has a flange 224 attached to the first sidewall 206, the second sidewall 208, the upper wall 210, and the lower wall 212. The flange 224 is adapted to secure the storage apparatus 100 to a wall ornament. Further, the flange 224 can have a plurality of holes 226 each of the plurality of holes 226 adapted to receive a fastener to secure the storage apparatus 200 to the wall ornament. In other embodiments, the storage apparatus has a door covering the chamber 204. In even further embodiments, the door has a lock. The lock can be any desired type of lock including, but not limited to key lock, combination lock, fingerprint lock, and the like.

The storage apparatus 200 can have a plurality of indentations 228 that are within the chamber 204. The indentations 228 can be any size and any shape; however, in the illustrated embodiment each of the indentations 228 are rectangular shaped and measure at approximately 4 cm (1.57 in) by 10 cm (3.94 in). The indentations 228 also need not be rectangular. The indentations 228 can be any shape including, but not limited to, circular, pentagonal, hexagonal, or the like. For example, the illustrated embodiment has a first indentation 230 in the first sidewall 206 and a second indentation 232 in a first distal wall 240. The chamber 206 can be further defined by the first distal wall 240. The first distal wall 240 is connected to the first sidewall 206 and the second sidewall 208. Each of the first and second indentations 230, 232 are adapted to receive a magnet, at least partially within the indentations 230, 232. Although the storage apparatus 200 has two indentations 230, 232, any number of indentations 230, 232 can be present. For example, the number of indentations 230, 232 can include, but is not limited to, one, three, four, five, six, seven, or the like. In the illustrated embodiment, a magnet 238 is removably disposed within the second indentation 232. The magnet 238 illustrated disposed within the second indentation 232 can be moved to any desired indentation 230, 232 to adjust to the preference of the individual using the storage apparatus 200. The storage apparatus 200 can have any number of magnets 238 including, but not limited to, one, two, three, four, five, or any other desired number that are releasably attached to any or all of the indentations 230, 232. The magnet 238 can be adapted to secure a firearm or any other object having metal within the chamber 204. In the illustrated embodiment, the storage apparatus 200 has a metallic member 242 embedded between the first distal wall 240 and the first distal end 216 that is positioned relative to the second indentation 232. There may also be a plurality of metallic members 242 embedded within any of the walls 206, 208, 210, 212, 240 of the storage apparatus 200, relative to the indentations 230, 232. The metallic members 242 can also be embedded in places in which there are no indentations present. Further, in alternative embodiments, metallic members 242 may be disposed on the outside of the storage apparatus 200 or within the chamber 204. The indentations 228 can be beneficial for a number of reasons. For example, the indentations 228 are beneficial at least because it prevents the magnet 138 from moving while the wall ornament is moved or bumped. Further, the indentations 228 can be used to add additional support to prevent the firearm, or other objects, being stored from getting damaged. For example, the indentations 228 can have a support member having a felt material disposed over the support member to support the firearm without scratching the firearm.

In the illustrated embodiment, a platform, such as in the first example storage apparatus 100, is not present. However, this embodiment could have the platform shown in the first example storage apparatus 100. In the illustrated embodiment, the storage apparatus 200 further comprises a compartment 248 having a first divider 254 that is disposed within the compartment 248, thus the divider creates a second compartment 256. The first divider 254 can be fixed, or it can be removeable as desired. The illustrated embodiment further has a second divider 258 disposed within the compartment that is similar to the first divider 254 or identical to the first divider 254. The presence of the second divider 258 creates a third compartment 260. The storage apparatus 200 can have any number of dividers 254, 258 including, but not limited to, one, three, four, or none.

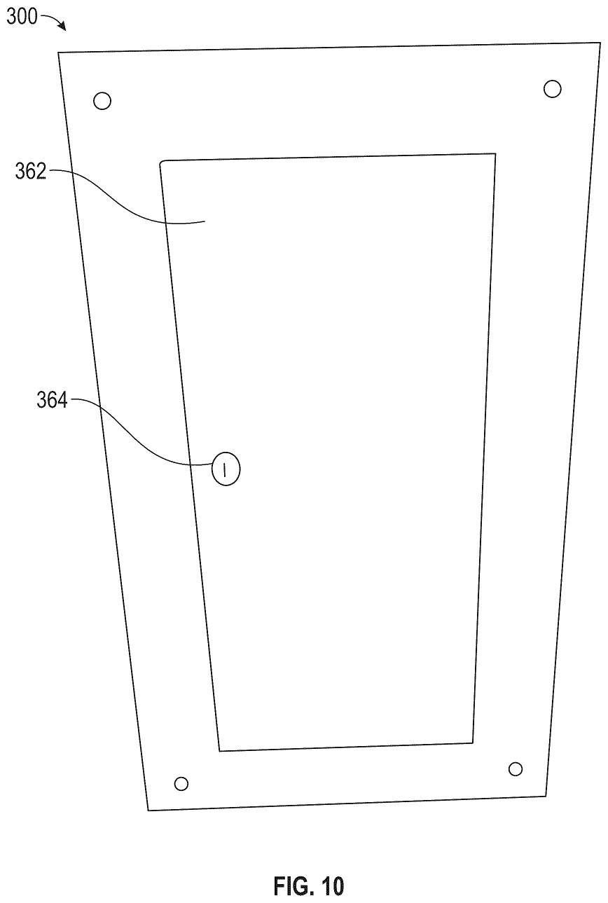

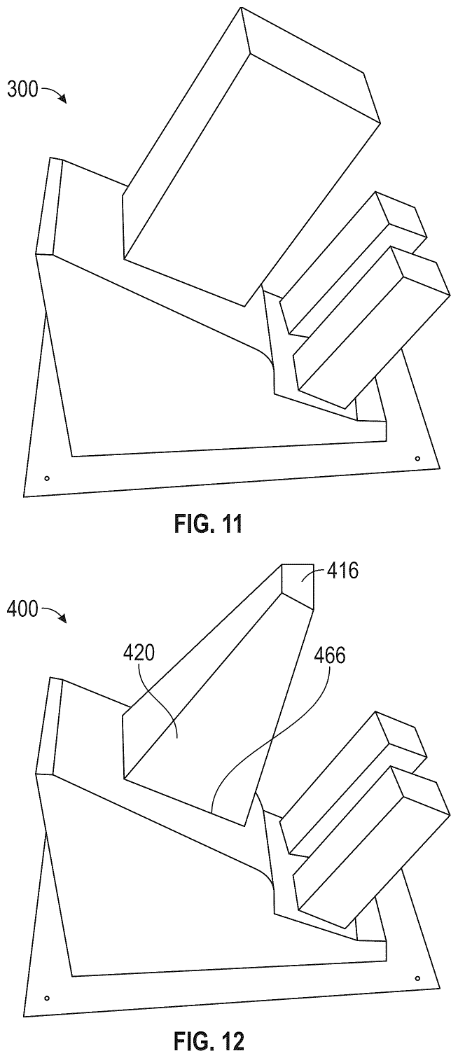

Each of FIGS. 10 and 11 illustrates a third example storage apparatus 300. The illustrated storage apparatus 300 is exactly as described above regarding the second example storage apparatus 200 besides as indicated as follows. As illustrated in FIG. 10 the storage apparatus 300 has a door 362 covering the chamber. Further, the door 362 has a lock 364. The lock 364 can be any desired type of lock including, but not limited to key lock, combination lock, fingerprint lock, and the like. Further, as illustrated in FIG. 11, the storage apparatus 300 only has a single divider and two compartments compared to the two dividers and three compartments in the second example storage apparatus 200. Further, the storage apparatus 300 can be made by a variety of different processes including, but not limited to, 3d printing, direct injection molding, and by any other desired means. The storage apparatus 300 can also be made from a variety of different materials including, but not limited to, polymers, metals, and the like.

FIG. 12 illustrates a fourth example storage apparatus 400. The illustrated storage apparatus 400 is exactly as described above regarding the third example storage apparatus 300 besides as indicated as follows. In the illustrated embodiment of the storage apparatus 400, a first portion 420 of a chamber is tapered from a plane 466 proximate to a first distal end 416 to the first distal end 416. Further, the storage apparatus 400 can be made by a variety of different processes including, but not limited to, 3d printing, direct injection molding, and by any other desired means. The storage apparatus 400 can also be made from a variety of different materials including, but not limited to, polymers, metals, and the like.

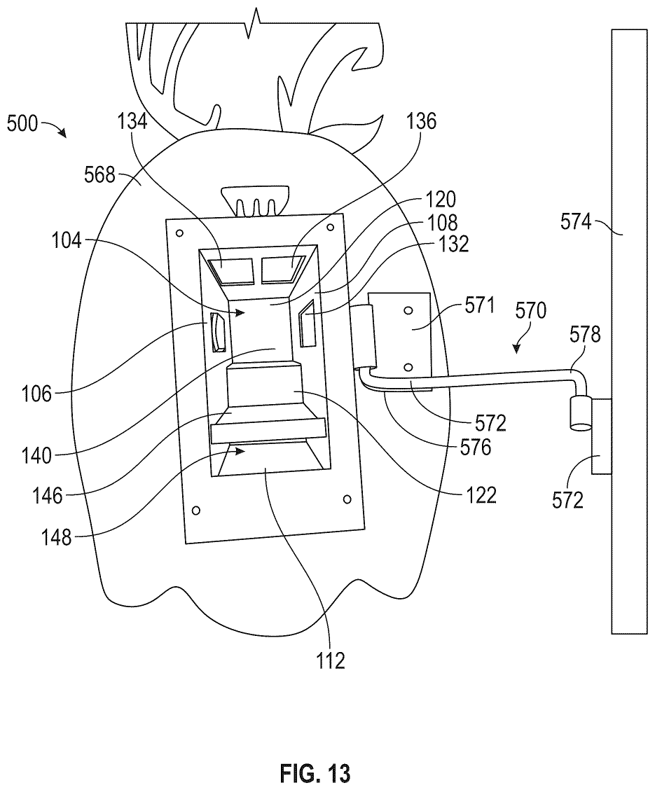

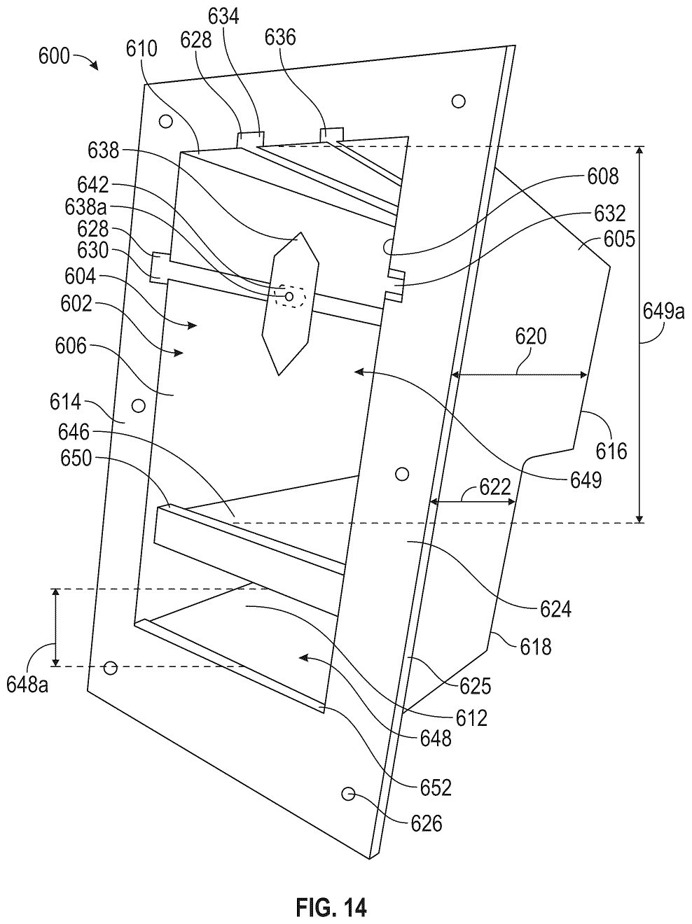

FIG. 13 illustrates a first example storage apparatus system 500. The storage apparatus system 500 includes a wall ornament 568, a storage apparatus 100 disposed within the wall ornament 568, and a bracket 570 having a bar 572, a first bracket member 571 and a second bracket member 573. The first bracket member 571 is attached to the wall ornament 568 by a fastener or any other desired means. The second bracket member 573 is attached to a wall 574 by a fastener or any other desired means. Extending between the first bracket member 571 and the second bracket member 572 is the bar 572. The bar 572 has a first curvature 576 and a second curvature 578. The bracket 570 is adapted to move the storage apparatus system 500. The bar 572 having the first curvature 576 and the second curvature 578 allows for the wall ornament 568 to move away from the wall 574 and change directions without causing damage to the wall. For example, an antler on a taxidermy mount of a deer might hit the wall 574 if the bracket 570 with the bar 572 is not used. The bar 572 of the bracket 570 allows the wall ornament 568 to move a distance away from the wall 574 when desired. Although this type of bracket 570 was used in the storage apparatus system 500, any desired type of bracket can be used to pivot the storage apparatus system 500 away from the wall 574.

The storage apparatus 100 is disposed in the wall ornament 568. In the illustrated embodiment, the wall ornament 568 is a taxidermy mount of a deer. However, the taxidermy mount can be of any type of animal including, but not limited, to bear, elk, bison, or the like. Although installing the storage apparatus 100 in a taxidermy mount is beneficial, the storage apparatus 100 can be installed in or designed integral to any type of wall hung decoration having dimensions that allows for the installation of the storage apparatus 100. Further, the storage apparatus 100 can be made by a variety of different processes including, but not limited to, 3d printing, direct injection molding, and by any other desired means. The storage apparatus 100 can also be made from a variety of different materials including, but not limited to, polymers, metals, and the like.

The storage apparatus 100 is the same as in the first example storage apparatus 100, as shown in each of FIGS. 1, 2, 3, 4, 5, 6, and 7. The storage apparatus 100 has an opening 102 that is rectangular; however, the opening 102 can be any desired shape including, but not limited to, circular, triangular, hexagonal, or the like. The opening 102 is adapted to receive an object. The storage apparatus 100 has a chamber 104 that is defined by a first sidewall 106, a second sidewall 108, an upper wall 110, a lower wall 112, a proximal end 114, a first distal end 116, and a second distal end 118. In the illustrations, the first sidewall 106 is relatively perpendicular to the upper wall 110. The upper wall 110 is relatively perpendicular to the second sidewall 108. The second sidewall 108 is relatively perpendicular to the lower wall 112. The lower wall 112 is relatively perpendicular to the first sidewall 106. Although the storage apparatus 100 is illustrated in this manner, the walls 106, 108, 110, 112 do not need to be perpendicular to each other. The walls can be positioned to have a variety of angles to form a variety of shapes depending on the type of object that will be stored. In the illustrated embodiment, the upper wall and lower wall have a width that is approximately 10 cm (3.94 in) measured from the first sidewall 106 to the second sidewall 108. A first portion 120 of the chamber 104 has a first length measured from a proximal end 114 to a first distal end 116. In the illustrated embodiment, the first portion 120 is approximately 23 cm (9.06 in) measured from the proximal end 114 to the first distal end 116. Further, a second portion 122 of the chamber 104 has a second length measured from the proximal end 114 to a second distal end 118. In the illustrated embodiment, the second portion 122 is approximately 13.5 cm (5.31 in) measured from the proximal end 114 to the second distal end 118. The first portion 120 and the second portion 122 need not be these exact dimensions. The first portion 120 and the second portion 122 can have any desired dimensions. The chamber 104 having these dimensions makes the chamber 104 adapted to receive a firearm. For example, a pistol, a revolver, or the like can be the type of firearms that the chamber 104 is adapted to receive. In further embodiments, the chamber 104 can be larger and adapted to store other types of firearms, such as shotguns and rifles, can be stored within the storage apparatus 100. In some embodiments, the first portion 120 of the chamber 104 is tapered from the proximal end 114 to the first distal end 116.

In the illustrated embodiment, the storage apparatus 100 further has a flange 124 attached to the first sidewall 106, the second sidewall 108, the upper wall 110, and the lower wall 112. The flange 124 is adapted to secure the storage apparatus 100 to a wall ornament. In the illustrated embodiment, the flange 124 is approximately 2 cm (0.79 in) from the first and second sidewalls 106, 108 to an outside edge 125 of the flange 124. Also, the flange 124 is approximately 2.5 cm (0.98 in) from the first and lower wall 110, 112 to the outside edge 125 of the flange 124. However, the flange 124 can be any desired dimensions. Further, the flange 124 can have a plurality of holes 126 each of the plurality of holes 126 is adapted to receive a fastener to secure the storage apparatus 100 to the wall ornament. In other embodiments, the storage apparatus 100 has a door covering the chamber 104. In even further embodiments, the door has a lock. The lock can be any desired type of lock including, but not limited to a key lock, a combination lock, a fingerprint lock, and the like.

The storage apparatus 100 can have a plurality of indentations 128 that are within the chamber 104. The indentations 128 can be any size and any shape; however, in the illustrated embodiment each of the indentations 128 are rectangular shaped and measure at approximately 4 cm (1.57 in) by 10 cm (3.94 in). The indentations 128 also need not be rectangular. The indentations 128 can be any shape including, but not limited to, circular, pentagonal, hexagonal, or the like. For example, the illustrated embodiment has a first indentation 130 in the first sidewall 106, a second indentation 132 is in the second sidewall 108, and a third and fourth indentation 134, 136 that are in the upper wall 110. Each of the first, second, third, and fourth indentations 130, 132, 134, 136 are adapted to receive a magnet 138, at least partially within the indentations 130, 132, 134, 136. Although the storage apparatus 100 has four indentations 130, 132, 134, 136, any number of indentations 130, 132, 134, 136 can be present. For example, the number of indentations 130, 132, 134, 136 can include, but is not limited to, one, two, three, five, six, seven, or the like. Further, the storage apparatus 100 can be further defined by a first distal wall 140 that is connected to the first sidewall 106 and the second sidewall 108. The first distal wall 140 can also have an indentation 130, 132, 134, 136 that is adapted to receive a magnet 138. In the illustrated embodiment, the magnet 138 is removably disposed within the first indentation 130, but the magnet 138 can be moved to any desired indentation 130, 132, 134, 136 to adjust for the preference of the individual using the storage apparatus 100. The storage apparatus 100 can have any number of magnets 138 including, but not limited to, one, two, three, four, five, or any other desired number that are releasably attached to any or all of the indentations 130, 132, 134, 136. The magnet 138 can be adapted to secure a firearm or any other object having metal within the chamber 104. In the illustrated embodiment, the storage apparatus 100 has a metallic member 142 embedded between the first sidewall 106 and a first sidewall outer surface 144 that is positioned relative to the first indentation 130. There may also be a plurality of metallic members 142 embedded within any of the walls 106, 108, 110, 112 of the storage apparatus 100. The metallic members 142 can also be embedded in places in which there are no indentations present. Further, in alternative embodiments, metallic members 142 may be disposed on the outside of the storage apparatus 100 or within the chamber 104. The indentations 128 can be beneficial for a number of reasons. For example, the indentations 128 are beneficial at least because it prevents the magnet 138 from moving while the wall ornament is moved or bumped. Further, the indentations 128 can be used to add additional support to prevent the firearm, or other objects, being stored from getting damaged. For example, the indentations 128 can have a support member having a felt material disposed over the support member to support the firearm or objects without causing damage.

The illustrated embodiment further has a platform 146 that is extends between the upper wall 110, the lower wall 112, the first sidewall 106, and the second sidewall 108. The platform 146 extends between the first sidewall 106 and the second sidewall 108. The platform 146 is in the chamber 104 and creates a first compartment 148. The first compartment 148 is defined by the platform 146, the first sidewall 106, the second sidewall 108, and the lower wall 112. The platform 146 can further have a platform lip 150 that is adapted to create a shelf within the storage apparatus 100 where objects will not fall off the platform 146. When the platform 146 is present in the storage apparatus 100, a reduced chamber 149 is defined by the first sidewall 106, the second sidewall 108, the upper wall 110, and the platform 146. In the illustrated embodiment, the first compartment 148 has a first height 148a and the reduced chamber 149 has a second height 149a. The first height 148a of the first compartment 148 being less than the second height 149a of the reduced chamber 149. Further, in the illustrated embodiment, the lower wall 112 has a compartment lip 152 that extends over a portion of the compartment 148. In alternative embodiments, the storage apparatus 100 may further comprise a first divider that is disposed within the compartment, thus the divider creates multiple compartments. The divider can be fixed, or it can be removeable as desired. The storage apparatus 100 can further have a second divider disposed within the compartment 148 that is similar to the first divider or identical to the first divider. The storage apparatus 100 can have any number of dividers including, but not limited to, one, two, three, four, or none.

FIG. 14 illustrates a first example storage apparatus 600. The storage apparatus 600 can be disposed in a wall ornament. One example of a wall ornament is a taxidermy mount of a deer. However, the taxidermy mount can be of any type of animal including, but not limited to bear, elk, bison, or the like. Although installing the storage apparatus 600 in a taxidermy mount is beneficial, the storage apparatus 600 can be installed in or designed integral to any type of wall hung decoration having dimensions that allows for the installation of the storage apparatus 600. Further, the storage apparatus 600 can be made by a variety of different processes including, but not limited to, 3d printing, direct injection molding, and by any other desired means. The storage apparatus 600 can also be made from a variety of different materials including, but not limited to, polymers, metals, and the like.

In the illustrated embodiment, the storage apparatus 600 has an opening 602 that is rectangular; however, the opening 602 can be any desired shape including, but not limited to, circular, triangular, hexagonal, or the like. The opening 602 is adapted to receive an object. The storage apparatus 600 has a chamber 604 that is defined by a housing 605 having a first sidewall 606, a second sidewall 608, an upper wall 610, a lower wall 612, a proximal end 614, a first distal end 616, and a second distal end 618. In the illustrations, the first sidewall 606 is relatively perpendicular to the upper wall 610. The upper wall 610 is relatively perpendicular to the second sidewall 608. The second sidewall 608 is relatively perpendicular to the lower wall 612. The lower wall 612 is relatively perpendicular to the first sidewall 606. Although the storage apparatus 600 is illustrated in this manner, the walls 606, 608, 610, 612 do not need to be perpendicular to each other. The walls can be positioned to have a variety of angles to form a variety of shapes depending on the type of object that will be stored. In the illustrated embodiment, the upper wall 610 and lower wall 612 have a width that is approximately 10 cm (3.94 in) measured from the first sidewall 606 to the second sidewall 608. A first portion 620 of the chamber 604 has a first length measured from a proximal end 614 to a first distal end 616. In the illustrated embodiment, the first portion 620 is approximately 23 cm (9.06 in) measured from the proximal end 614 to the first distal end 616. Further, a second portion 622 of the chamber 604 has a second length measured from the proximal end 614 to a second distal end 618. In the illustrated embodiment, the second portion 622 is approximately 13.5 cm (5.31 in) measured from the proximal end 614 to the second distal end 618. The first portion 620 and the second portion 622 need not be these exact dimensions. The first portion 620 and the second portion 622 can have any desired dimensions. The chamber 604 having these dimensions makes the chamber 604 adapted to receive a firearm. For example, a pistol, a revolver, or the like can be the type of firearms that the chamber 604 is adapted to receive. In further embodiments, the chamber 604 can be larger and adapted to store other types of firearms, such as shotguns and rifles, can be stored within the storage apparatus 600. In some embodiments, the first portion 620 of the chamber 604 is tapered from the proximal end 614 to the first distal end 616.

In the illustrated embodiment, the storage apparatus 600 further has a flange 624 attached to the first sidewall 606, the second sidewall 608, the upper wall 610, and the lower wall 612. The flange 624 is adapted to secure the storage apparatus 600 to a wall ornament. In the illustrated embodiment, the flange 624 is approximately 2 cm (0.79 in) from the first and second sidewalls 606, 608 to an outside edge 625 of the flange 624. Also, the flange 624 is approximately 2.5 cm (0.98 in) from the first and lower wall 610, 612 to the outside edge 625 of the flange 624. However, the flange 624 can be any desired dimensions. Further, the flange 624 can have a plurality of holes 626. Each of the plurality of holes 626 is adapted to receive a fastener to secure the storage apparatus 600 to the wall ornament. In other embodiments, the storage apparatus 600 has a door covering the chamber 604. In even further embodiments, the door has a lock. The lock can be any desired type of lock including, but not limited to a key lock, a combination lock, a fingerprint lock, and the like.

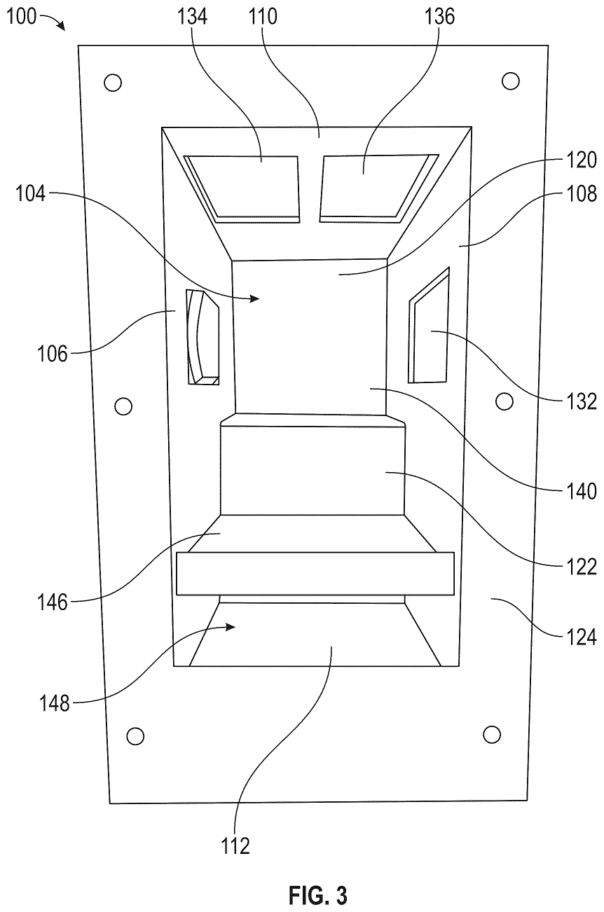

The storage apparatus 600 can have a plurality of indentations 628 that are within the chamber 604. The indentations 628 can be any size and any shape; however, in the illustrated embodiment each of the indentations 628 are t-slots that extend from the proximal end 614 to the first distal wall. The first distal wall in this embodiment is the same as the first distal wall 120, as shown in FIG. 3. For example, the illustrated embodiment has a first indentation 630 in the first sidewall 606, a second indentation 632 is in the second sidewall 608, and a third and fourth indentation 634, 636 that are in the upper wall 610. Each of the first, second, third, and fourth indentations 630, 632, 634, 636 are adapted to receive a metallic member 642. In the illustrated embodiment, the metallic member 642 is a hex nut; however, the metallic member 642 can be any type of nut or other types of metallic members 642. A magnet 638 is disposed, at least partially, over at least one of the indentations 630, 632, 634, 636. The magnet 638 can have a hole 638a therethrough that is adapted to receive a bolt. The bolt secures the magnet 638 within the chamber 604 by threading into the metallic member 642. The bolt and the metallic member 642 will tighten the magnet 638 against the first sidewall 606. Although the storage apparatus 600 has four indentations 630, 632, 634, 636, any number of indentations 630, 632, 634, 636 can be present. For example, the number of indentations 630, 632, 634, 636 can include, but is not limited to, one, two, three, five, six, seven, or the like. Further, the storage apparatus 600 can be further defined by the first distal wall 640 that is connected to the first sidewall 606 and the second sidewall 608. In the illustrated embodiment, the metallic member 642 is removably disposed within the first indentation 630, but the metallic member 642 can be moved to any desired indentation 630, 632, 634, 636 to adjust for the preference of the individual using the storage apparatus 600. The storage apparatus 600 can have any number of metallic members 642 and magnets 638 including, but not limited to, one, two, three, four, five, or any other desired number. The magnet 638 can be adapted to secure a firearm or any other object, having metal, within the chamber 604. There may also be a plurality of metallic members 642 embedded within any of the walls 606, 608, 610, 612 of the storage apparatus 600. The metallic members 642 can also be embedded in places in which there are no indentations present. Further, in alternative embodiments, metallic members 642 may be disposed on the outside of the storage apparatus 600 or within the chamber 604. The indentations 628 can be beneficial for a number of reasons. For example, the indentations 628 in combination with the metallic member 642 and a bolt are beneficial at least because it prevents the magnet 638 from moving while the wall ornament is moved or bumped. Further, the indentations 628 can be used to add additional support to prevent the firearm, or other objects, being stored from getting damaged. For example, the indentations 628 can have a support member having a felt material disposed over the support member to support the firearm or objects without causing damage.

The illustrated embodiment further has a platform 646 that is extends between the upper wall 610, the lower wall 612, the first sidewall 606, and the second sidewall 608. The platform 646 extends between the first sidewall 606 and the second sidewall 608. The platform 646 is in the chamber 604 and creates a first compartment 648. The first compartment 648 is defined by the platform 646, the first sidewall 606, the second sidewall 608, and the lower wall 612. The platform 646 can further have a platform lip 650 that is adapted to create a shelf within the storage apparatus 600 where objects will not fall off the platform 646. When the platform 646 is present in the storage apparatus 600, a reduced chamber 649 is defined by the first sidewall 606, the second sidewall 608, the upper wall 610, and the platform 646. In the illustrated embodiment, the first compartment 648 has a first height 648a and the reduced chamber 649 has a second height 649a. The first height 648a of the first compartment 648 being less than the second height 649a of the reduced chamber 649. Further, in the illustrated embodiment, the lower wall 612 has a compartment lip 652 that extends over a portion of the compartment 648. In alternative embodiments, the storage apparatus 600 may further comprise a first divider that is disposed within the compartment, thus the divider creates multiple compartments. The divider can be fixed, or it can be removeable as desired. The storage apparatus 600 can further have a second divider disposed within the compartment 648 that is similar to the first divider or identical to the first divider. The storage apparatus 600 can have any number of dividers including, but not limited to, one, two, three, four, or none.

Those with ordinary skill in the art will appreciate that various modifications and alternatives for the described and illustrated examples can be developed in light of the overall teachings of the disclosure, and that the various elements and features of one example described and illustrated herein can be combined with various elements and features of another example without departing from the scope of the invention. Accordingly, the particular examples disclosed herein have been selected by the inventors simply to describe and illustrate examples of the invention and are not intended to limit the scope of the invention or its protection, which is to be given the full breadth of the appended claims and any and all equivalents thereof.

We claim:

1. A storage apparatus, comprising:
a chamber;
an opening, the opening providing access to the chamber;
a first sidewall, a second sidewall, an upper wall, and a lower wall, the first sidewall, the second sidewall, the upper wall, and the lower wall defining the opening to the chamber;
a proximal end, a first distal end, and a second distal end, the first sidewall having a first length measured from the proximal end to the first distal end, the first sidewall having a second length measured from the proximal end to the second distal end, the first length being greater than the second length; and
a magnet, the magnet on the first sidewall.

2. The storage apparatus of claim 1, further comprising a platform between the upper wall and the lower wall.

3. The storage apparatus of claim 2, further comprising a compartment defined by the platform, the first sidewall, the second sidewall, and the lower wall.

4. The storage apparatus of claim 2, wherein the platform has a platform lip.

5. The storage apparatus of claim 3, further comprising a divider within the compartment.

6. The storage apparatus of claim 1, further comprising a first indentation in the first sidewall.

7. The storage apparatus of claim 6, further comprising a second indentation in the second sidewall.

8. The storage apparatus of claim 1, wherein the lower wall has a compartment lip.

9. The storage apparatus of claim 7, wherein the magnet releasably attached to the first indentation.

10. The storage apparatus of claim 5, further comprising a second divider within the compartment.

11. The storage apparatus of claim 1, further comprising a flange on the first sidewall, the second sidewall, the upper wall, and the lower wall.

12. The storage apparatus of claim 11, wherein the flange has a plurality of holes, each of the plurality of holes adapted to receive a fastener.

13. The storage apparatus of claim 1, further comprising a first distal wall that is connected to the first sidewall and the second sidewall.

14. The storage apparatus of claim 13, wherein the first distal wall has a second indentation.

15. The storage apparatus of claim 1, wherein the chamber is configured to receive a firearm.

16. The storage apparatus of claim 1, wherein the chamber is tapered from the proximal end to the first distal end.

17. The storage apparatus of claim 1, further comprising a door, the door covering the opening of the chamber.

18. The storage apparatus of claim 17, wherein the door has a lock.

19. A storage apparatus, comprising:
a chamber;
an opening, the opening providing access to the chamber;
a first sidewall, a second sidewall, an upper wall, a lower wall, and a first distal wall, the first sidewall, the second sidewall, the upper wall, the lower wall, and the first distal wall defining the opening to the chamber;
a proximal end, a first distal end, and a second distal end, the sidewall having a first length measured from the proximal end to the first distal end, the first sidewall having a second length measured from the proximal end to the second distal end, the first length being greater than the second length; and
a magnet, the magnet on the first distal wall.

20. A storage apparatus system comprising:
a wall ornament;
a storage apparatus, the storage apparatus disposed within the wall ornament, the storage apparatus having a chamber, an opening, a first sidewall, a second sidewall, an upper wall, a lower wall, a proximal end, a first distal end, and a second distal end, the opening providing access to the chamber, the first sidewall, the second sidewall, the upper wall, and the lower wall defining the opening to the chamber, the first sidewall having a first length measured from the proximal end to the first distal end, the upper wall having a second length measured from the proximal end to the second distal end, the first length being greater than the second length
a magnet, the magnet on the first sidewall; and
a bracket, the bracket attached to the wall ornament.
